(19) United States
(12) Patent Application Publication
(10) Pub. No.: US 2014/0229882 A1
(43) Pub. Date: Aug. 14, 2014

(54) USER INTERFACE FOR ADVANCED INPUT FUNCTIONS

(71) Applicant: Syntellia, Inc., San Francisco, CA (US)

(72) Inventors: Kosta Eleftheriou, San Francisco, CA (US); Vasileios Rappos, San Francisco, CA (US)

(73) Assignee: Syntellia, Inc., San Francisco, CA (US)

(21) Appl. No.: 14/172,814

(22) Filed: Feb. 4, 2014

Related U.S. Application Data
(60) Provisional application No. 61/762,700, filed on Feb. 8, 2013.

(51) Int. Cl. G06F 3/0481; G06F 17/24

(52) U.S. Cl. CPC G06F 3/0481; G06F 17/24
USPC 715/773

(57) ABSTRACT

The user interface allowing users to intuitively interact with a virtual keyboard to enter text containing non-alphabetic characters. The user interface uses a special purpose key to input a symbol which can be automatically interpreted as the intended symbol by the device.

### CROSS REFERENCE TO RELATED APPLICATIONS

This application claims priority to U.S. Provisional Application No. 61/762,700, “User Interface For Advanced Input Functions” filed Feb. 8, 2013, the contents of which is hereby incorporated by reference.

### FIELD OF INVENTION

This invention relates to user interfaces and in particular to text input.

### BACKGROUND OF THE INVENTION

The present invention relates to devices that are capable of receiving and processing text via a virtual keyboard. Such devices include, for example, computers and phones featuring touch screens, or other recording devices able to record the movement of fingers on a plane or in three-dimensional spaces.

Many existing electronic devices user finger interaction to provide input signals and information. These finger interactions are typically through a touch screen. These devices include mobile telephones, tablet computers, mobile computers, PDAs and satellite navigation assistants. The growth in the use of smartphones and tablets has increased the user of touch screen inputs.

Many devices that include a touch screen emulate a keyboard text entry system. These devices typically display a virtual keyboard on screen, with users tapping on the different letters of the virtual keyboard to input text. However, the lack of tactile feedback can result in more errors when typing on virtual keyboards in comparison to typing on hardware keyboards. Therefore, it is common for these virtual keyboard systems to feature “autocorrect” functionality, which compensates for typing errors by applying logic to infer the intended word when the user has accidentally mistyped a word.

Such autocorrect systems typically compare input based upon the detected text inputs on each key of the virtual keyboard with a word dictionary. If the word is recognized, the system proceeds with the next word input. However, where the entered text is not a recognized word, these systems determine the closest dictionary match and then replace the input text with the closest dictionary match. These dictionaries typically include common words and names. However, these correction systems are typically not compatible with inputs that mix letters, numbers and/or symbols, for example e-mail addresses and passwords that include a combination of letters, numbers and/or symbols. The present invention is directed towards an autocorrect system that will correct text inputs that include combinations of letters, numbers and/or symbols.

### SUMMARY OF THE INVENTION

There are some input situations that require a user to input of text which contains combinations of alphabetic characters, with numeric and/or symbol characters, for example an email address, a URL, a password, etc. The autocorrect functionality of the device is commonly turned off automatically for text input. Because the prior art auto correct systems rely upon dictionaries that only recognize words, the input of text that includes letters, numbers and/or symbols such as email addresses, URLs, and passwords requires precise input by the user, without the assistance of autocorrect.

The present invention describes functions allowing users a more intuitive interaction with a software keyboard for entering text containing non-alphabetic characters. The invention takes advantage of user interface innovations possible on a software keyboard environment, and makes inputting such text a lot simpler by providing auto-correct functionality.

### BRIEF DESCRIPTION OF THE DRAWINGS

FIG. 1 illustrates a top view of a device having a touch screen and virtual keyboard;

FIG. 2 illustrates an example of an input with mixed text with letters and a symbol;

FIG. 3 illustrates a top view of a device having physical input buttons;

FIG. 4 illustrates an example of an input text with mixed text with letters, punctuation and a symbol;

FIG. 5 illustrates an example of an input error correction of mixed text with letters and a symbol;

FIG. 6 illustrates a virtual keyboard;

FIG. 7 illustrates a coordinate system with relative locations of letters and a special purpose key;

FIG. 8 illustrates a block diagram of components of a device; and

FIG. 9 illustrates a flow chart of correction for input text.

### DETAILED DESCRIPTION OF THE INVENTION

The invention describes a device comprising a display capable of presenting a virtual keyboard, an area where the user input text can be displayed, and a touch-sensitive controller such as a touch pad or a touch screen. However, in other embodiments, a screen or a touch-sensitive controller may not be required to perform the method of the claimed invention. For example, in an embodiment, the input device can simply be the user's body or hands and a controller that is able to understand the user's finger movements in order to produce the desired output. The inventive system can recognize these inputs and provide an output that can be either be displayed on a screen or emitted as audio signals through an audio output device. For example, the input device may be a camera such as a Microsoft Kinect controller that is directed at the user. The cameras can detect the movement of the user and the output can be transmitted through speakers or other audio devices such as headphones. Optionally, the output can be transmitted through an output channel capable of audio playback, such as speakers, headphones, or a hands-free ear piece.

In some embodiments, the device may be a mobile telephone or tablet computer. In these embodiments, the text display and touch-sensitive controller may both be incorporated in a single touch-screen surface or be separate components.

The inventive system provides a keyboard layout for entering text containing both alphabetic and non-alphabetic characters. This keyboard layout may be displayed by a device in applications or use cases when such text is expected to be input. For example, it may be displayed in a web browser application when the user is entering a web address, or on email clients when the user is entering email addresses. In other embodiments, the keyboard layout may optionally be offered across all system operations where text input is performed by the user, and be either enabled by default or selectable amongst a range of keyboard layouts.

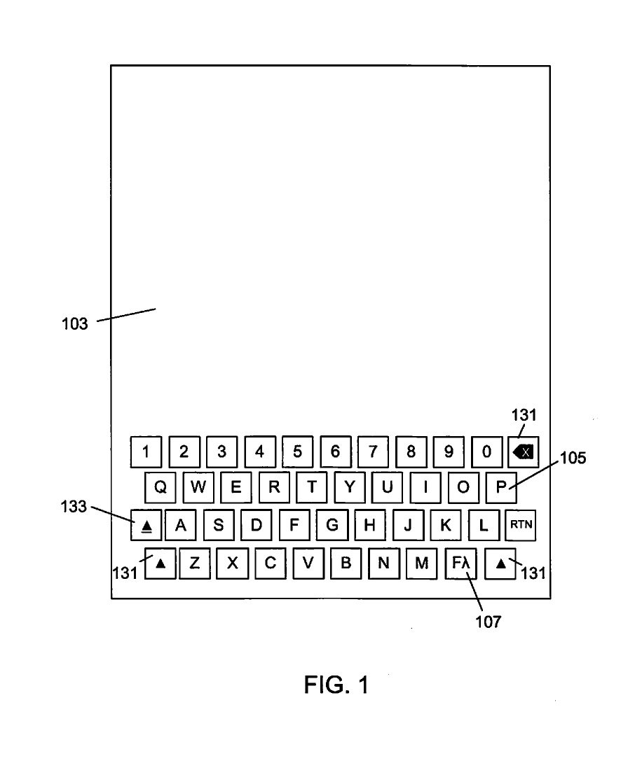

FIG. 1 shows an embodiment of the inventive system 100 which includes a touch screen 103 input device, a virtual keyboard 105 displayed on the touch screen 103 and a special purpose key 107. The keyboard 105 may have any layout. A QWERTY layout may be the most commonly used keyboard. However, a keyboard in any other language or layout such as DVORAK, or other keyboard layout, and will feature all alphabetic characters can be used. In addition to the normal letter keys, the inventive system can also include a special purpose symbol key 107 that may be positioned alongside the other buttons or on any other location. In the illustrated embodiment, the special purpose key is marked “Fλ.” and is adjacent to the “M” letter key on the lower right portion of the keyboard 105. In other embodiments, the special purpose key 107 can be marked in any other manner on a virtual keyboard 105 that would identify the special key 107. The system may also have a keyboard that features other function keys, such as a shift 131 and a caps lock 133, back space 135 or other symbol or number keys, in line with typical keyboard layouts. It is also possible for the system to have a special purpose key can be a physical button on the device. For example, if the inventive system is used with a smart watch, the special purpose button can be a physical button on any surface of the smart watch.

In contrast to word correction systems, the inventive system can effectively perform auto-correction of text that is a mixture of letters, numbers and/or symbols. In order to perform this functionality, the system will store a database of tokens, each token being a single text sequence containing a combination of letters, numbers and/or symbols. These tokens can represent passwords, e-mail addresses, URLs or any other text that includes a mixture of letters, numbers and/or symbols that cannot be processed by word autocorrect systems. The system can be used to construct a unique personalized database of tokens for each user. The inventive system can recognize the tokens typed by each user because each token contains one or more non-alphabetic characters which can be numbers, punctuation marks and/or symbols. This token input to the database of tokens may be done using set rules that define sets of valid tokens.

Once the token has been input, the system can be saved in the token database. The token saving can be done with a keyboard interface featuring a dedicated special purpose key. The inventive system can confirm the input of a token by displaying a token confirmation notification on the display and/or emitting a token confirming audio signal. The token database may also incorporate existing databases of email addresses, URLs, and/or other text tokens that may contain non alphabetic characters. The system and process for saving and using tokens is described below.

In an embodiment, the inventive system can construct a database of tokens. Each token can contain a sequence of both alphabetic and non alphabetic characters that are likely to be input by the user during normal touch screen inputs. Examples of such mixed character tokens include: email addresses, website addresses, and passwords, but may also include other use cases like car registration numbers and others symbols and/or punctuation marks such as: !, @, #, $, %, ̂, &, *, +, etc.

In some embodiments of the invention, the database may be constructed using sets of pre-programmed rules. The rules may include common constructions of tokens.

For example, in an embodiment of the inventive the system may recognize the rule that a token is constructed in the format such as firstname.surname@gmail.com, firstinitialsurname@gmail.com, firstname.surname@(email provider).com, firstinitialsurname@(email provider).com. Table 1 is an example of an email token database.

TABLE 1

| Email Token Rules | Email Provider |
|---|---|
| @gmail.com | Google |
| (first name).(lastname)@gmail.com | Google |
| @hotmail.com | Microsoft |
| (first initial)(last name)@hotmail.com | Microsoft |
| @yahoo.com | Yahoo |
| (first name)(last name)(number) @yahoo.com | Yahoo |
| @yourcompany.com | Company e-mail address |
| (first name)@yourcompany.com | Company e-mail address |

When the system detects an input that corresponds or matches this input format, the token rules can be used to identify the input as an email address, and therefore correctly allow the input email address to be input by the system. These embodiments may use such pre-programmed rules to construct a database of allowable tokens in bulk. Examples of possible token rules or token formats are listed in Table 1. In an embodiment, the bulk e-mail addresses can be stored as separate listings in an e-mail token database. In other embodiments, the inventive system may store these logical rules as a separate database.

In other embodiments of the invention, the database may be constructed by incorporating pre-existing databases of tokens. These pre-existing tokens can be specific types of tokens. For example in an embodiment, a pre-existing set of URL tokens can be added to a database of valid URLs may be used by the inventive system to be included in a list of allowable tokens. Some embodiments may also refer to the device's address book as a data source, and pre-populate all stored e-mail addresses as allowable tokens. Table 2 illustrates a plurality of possible tokens that are commonly known URLs.

TABLE 2

| Pre-Populated URL tokens | Company |
|---|---|
| www.amazon.com | Amazon |
| www.apple.com | Apple |
| www.bankofamerica.com | Bank of America |
| www.cnn.com | Cable News Network |
| www.fedex.com | Federal Express |

Some embodiments of the invention may use a dedicated data structure to store valid tokens. In these embodiments, all instances of a symbol in a token can be replaced by a dedicated data structure. For instance, the text “test@abc.com” may be stored as test?abc?com where “?” is a dedicated data structure that is used to indicate one or more specific symbol characters such as “.” and “@.” This particular data structure may enable certain advanced auto-correct functions and it can be consistent with the method that is used to enter text onto the inventive system.

In some embodiments of the inventive system, the user may be able to store their own custom tokens to the token database of the inventive system. For instance, this may be done by entering a custom user specific token manually on a keyboard. This can be particularly useful for personal mixed letter, number and symbol text such as passwords. In an embodiment, the inventive system may prompt the user to save the input custom tokens and in other embodiments, the inventive system may recognize that the same custom token has been input several times and automatically save the custom token after it has been entered a predetermined number of times. For example, if the same custom token has been entered 3, 4 or 5 times, the system can store the custom token in the token database. In other embodiments, the inventive system may include combinations of the described token input methods for constructing a database of valid tokens.

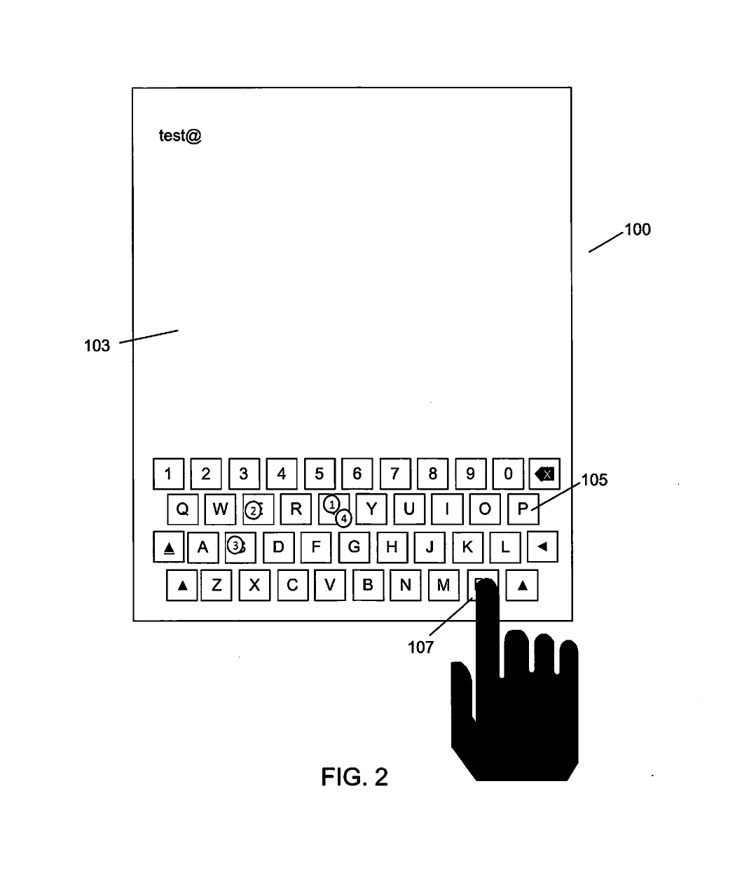

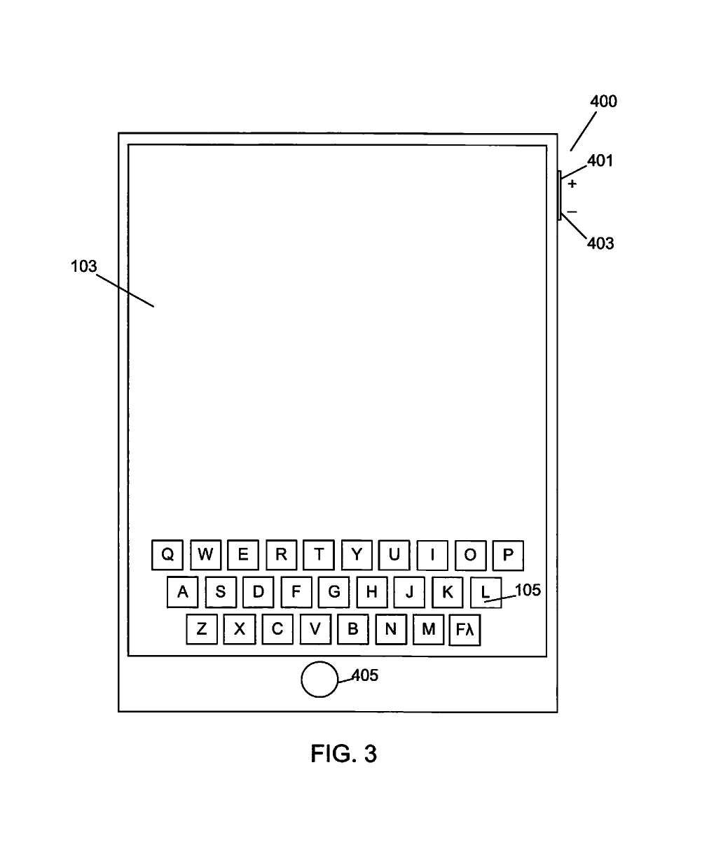

In an embodiment of the inventive system, a user will use a virtual keyboard to enter text. With reference to FIG. 2, a user is utilizing a virtual keyboard 105 to input text on an embodiment of the system. The user will tap once on each letter of the keyboard that they wish to input and the system will respond by displaying the tapped letter. In this example, the user has typed “test@.” The tap locations for the letters and sequence on the virtual keyboard are indicated by the circled numbers 1 through 4.

Where the user's input is intended to contain non-alphabetic text, in an embodiment the user can substitute every such character with a tap on the dedicated symbol key such as the special “Fλ” key 107. The inventive system will register this input as an indication from the user of their desire to input a non-alphabetic character. In this example, the user has tapped the special “Fλ” key 107 to input the “@” symbol. Upon completion of the input of the user, the user can notify the inventive system that he has completed typing a token. This notification might be by pressing the space button, an enter button, or by tapping or swiping on a dedicated area of the screen. In other embodiments, the system can use a physical button on the device to indicate the token input. With reference to FIG. 3 an electronic device 400 can include a plurality of physical buttons 401, 403 and 405 that can be pressed by the user to indicate that a token has been input. In this example, the button 401 and the button 403 are on the side and the button 405 is on the display 103 side of the mobile device 400. The mobile device 400 can be any device having a touch display 103 input mechanism including a tablet computer, a smart watch, etc.

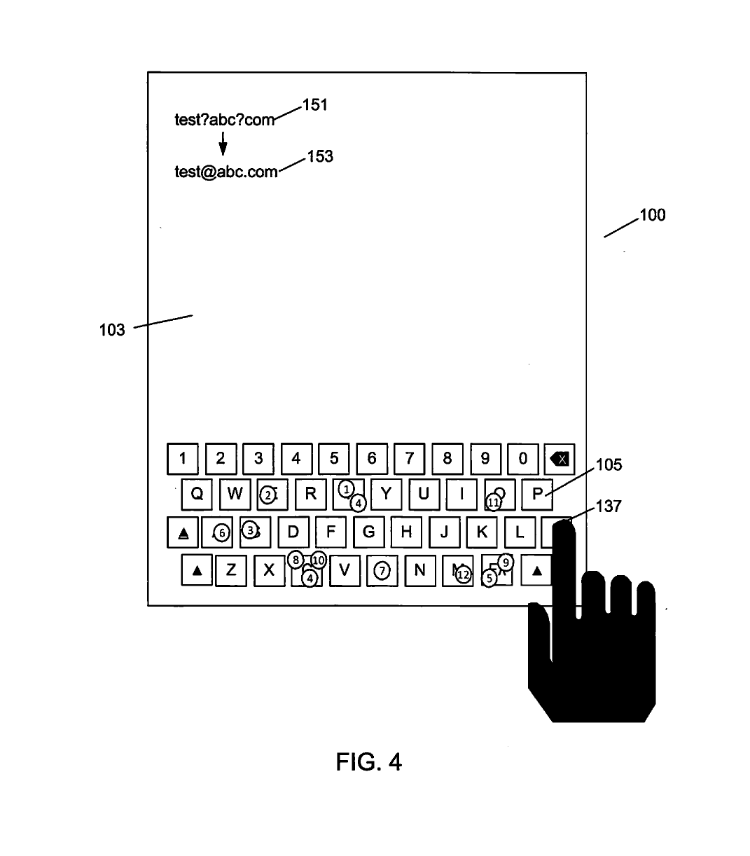

FIG. 4 shows an example of a mixed letter and symbol input in an embodiment of the system. The user wants to type “test@abc.com” into the system. The user can do this by pressing the button T, E, S and T letters on the virtual keyboard as indicated by circled numbers 1 through 4 first. Then the user presses the dedicated function button “Fλ” shown as circled number 5 to indicate the desire to enter a special character. The user can then press the A, B and C letter keys (circled numbers 6, 7 and 8) and then the dedicated function button “Fλ” (circled number 9) again. Finally, the user can press the C, O and M letter keys (circled numbers 10, 11 and 12). The user may press the “Enter” button 137 to indicate the end of the token.

The inventive system can then store the input of mixed letters and a symbol text as a single token of text, replacing instances of the dedicated function button “Fλ” with a dedicated data structure. In the above example, an embodiment of the system may store the text “test?abc?com” 151 in its memory, where “?” denotes the data structure representing the dedicated symbol button. However, are upon the context of the input and/or token rules, the system can interpret the input “test?abc?com” 151 as “test@abc.com” 153 and make these changes when the described input sequence of letters, numbers and/or symbols are completed and displayed.

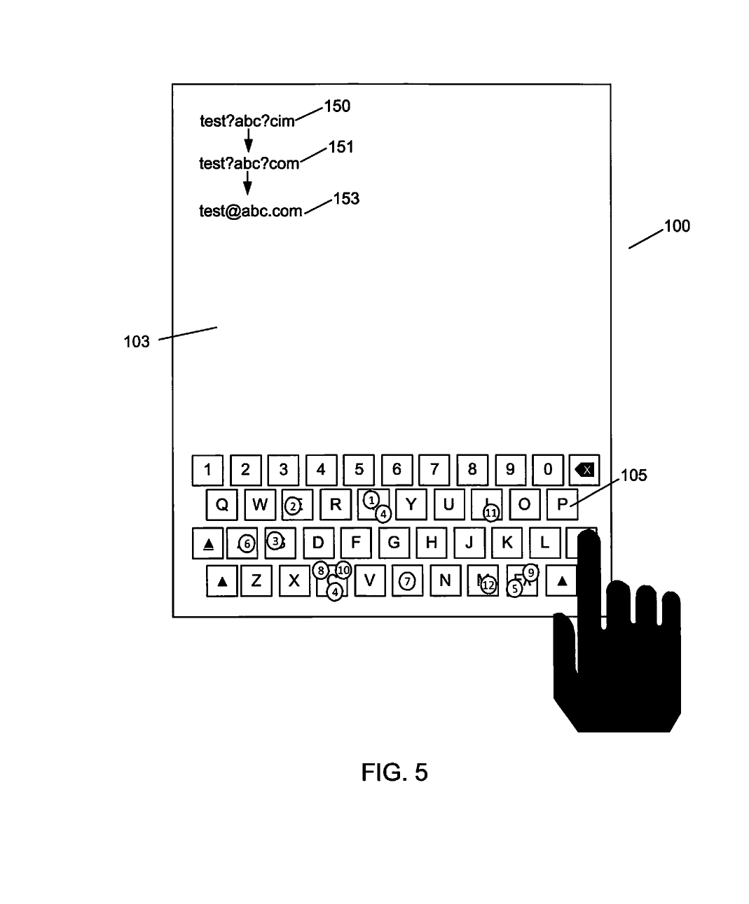

FIG. 5, illustrates an example of a typographical error in a mixed letter and symbol text input. In this example, the user accidentally typed “test?abc?cim” 150 (circled numbers instead of “test?abc?com” 151. The inventive system can correct the typographical error based upon the stored tokens or token rules via the described autocorrect process. The inventive system can also replace the “?” with the appropriate text based upon the token rules so that in this example, the text can be displayed as “test@abc.com” 153.

In some embodiments, the system may additionally store the location coordinates of the user taps and use these in an autocorrect process. For example, the input text can be based upon relative location coordinates rather than the actual taps over the letters of the virtual keyboard. In an embodiment, the inventive system can input letters and the special function button “Fλ” based upon relative coordinates or gestures rather than the physical positions of the letters on the virtual keyboard.

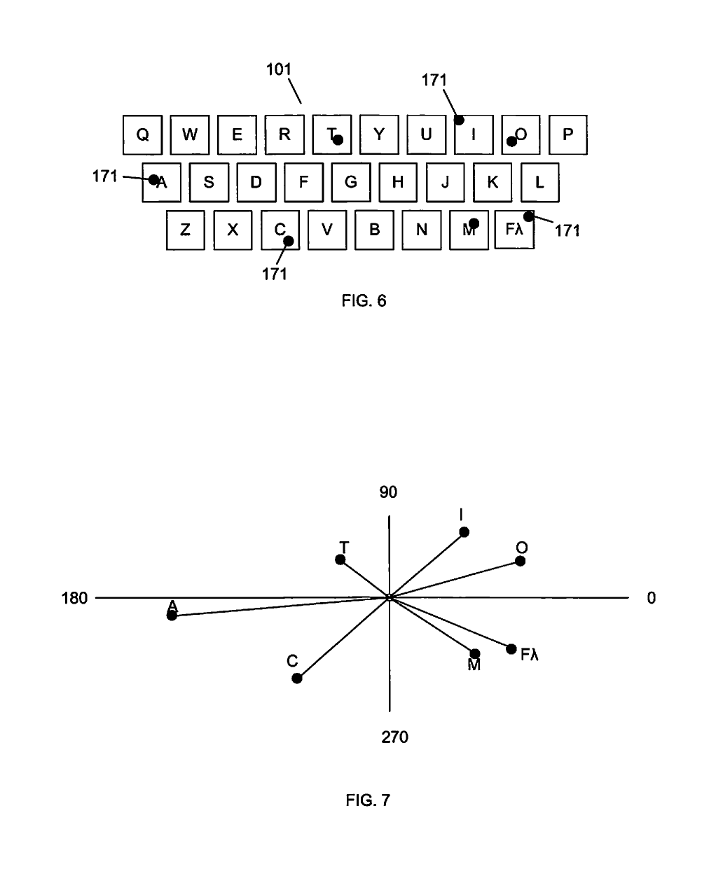

FIG. 6 illustrates a touch screen type input device 101 and a user can type in words by sequentially touching the letters of the keyboard that spell the word. In this example, the work “atomic?” can be represented by the sequence of seven virtual keyboard point locations 171. With reference to FIG. 7, as discussed above, the locations of the touch point can be converted to points based upon their positions on the screen or relative to an anchor point. This data input system is described in U.S. patent application Ser.. No. 13/531,200, “Data Input System And Method For Touch Sensor Input” which is hereby incorporated by reference in its entirety.

Since the location detection is completely independent of any markings on the input device, a keyboard does not have to be displayed at all on the input device. Because the words are based upon the positions rather than the specific displayed buttons that are typed, the inventive system is not confined to a defined keyboard area of the input device. The user can type the words in any scale and in any rotation or translation on the input device and the system will be able to determine an intended word. Because many users may be able to touch type and be familiar with the relative locations of the different alphabetical keys, these users can type on a displayed keyboard or a blank touch sensitive input device without the displayed keyboard. Alternatively, a very small keyboard layout can be displayed off of the touch sensitive portion as a reference for users who do not have the keyboard layout memorized. By eliminating the keyboard, more of the display is available for displaying other information. This may be particularly useful for mobile phone users who have small touch sensitive screens who would like to display as much information as possible.

In an embodiment, the inventive system will analyze text entered by the user and provide auto-correct functionality by using the database of valid tokens, and by treating the input of the user as a word of text, with the “special symbol” represented as a special character of input. In a simplified example, the token database may include the data in table 3 below. The user can input the text, “abd?test?com” and the system can compare the input text to the token database. The system can determine that the input text “abd?test?com” is very close to abc?test?com and make the auto correction to abc@test.com. However, if completely unrelated text is input such as john?doe?com, the system will not perform an autocorrection because there are no tokens that are similar enough to any of the stored tokens. Similarly, the system will not provide any correction for a completely random input such as “kjdhfashdsghasdg.”

TABLE 3

| Token | Text |
|---|---|
| abc?test?com | abc@test.com |
| Ioannis?syntellia?com | ioannis@syntellia.com |
| Kostas?syntellia?com | kostas@syntellia.com |

A similar process can be used for password tokens. In order to make stronger passwords, security systems can request or require a mixture of letter, case (upper and lower) number and symbol keys. While these requirements provide improved security, they can also be difficult to input each time a user needs to pass through a security system when the password is a long and complicated mixed letter, number, case, symbol, and text. Table 4 illustrates an example of possible password tokens. If a user inputs “pa??word”, the system can find the matching token and display the text “pa$$word.” If the input text is “p?sdwird”, the inventive system could autocorrect this input to the token “p?ssword” and display the text p@ssword.

TABLE 4

| Token | Text |
|---|---|
| p?ssword | p@ssword |
| pa??word | pa$$word |
| p???word | p@$$word |

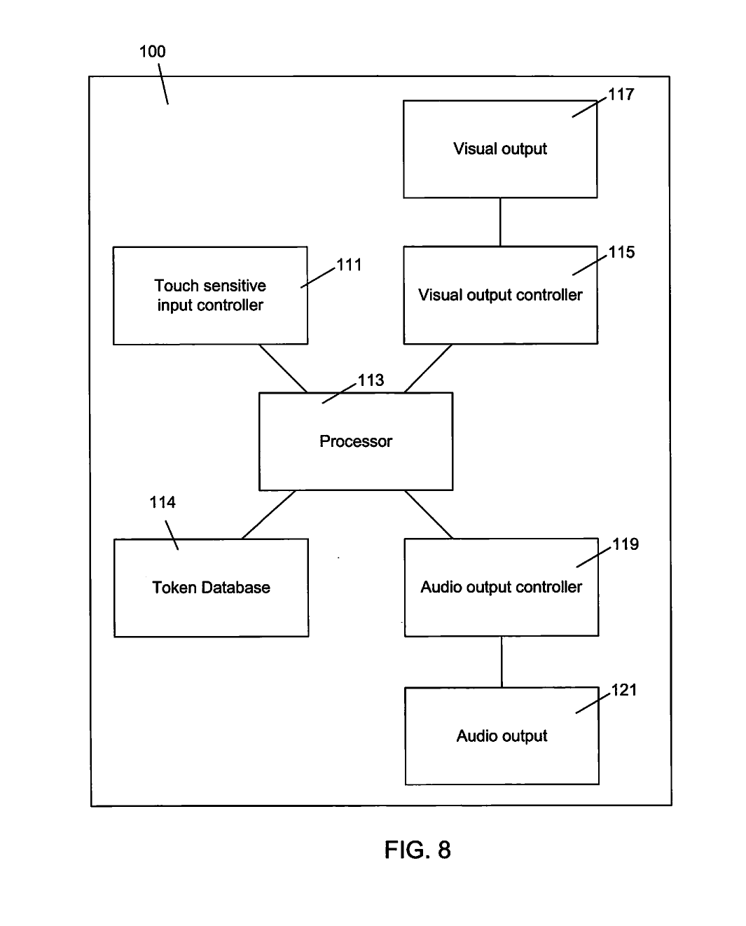

FIG. 8 illustrates a block diagram of an embodiment of the device 100 that can perform the described correction. The device 100 may comprise: a touch-sensitive input controller 111, a processor 113, a token database 114, a visual output controller 115, a visual display 117, an audio output controller 119, and an audio output 121. The user has input a token, which is stored in the token database 114 memory. The token may include some instances of the dedicated symbol button, hereby indicated with the symbol “?”. In other embodiments, any other symbol can be used. The inventive system 100 can use a processor 113 to match user inputs to the likely tokens in the token database 114.

The inventive system will then treat the input as a “word” of text, in a similar fashion to other autocorrect functions of the system. In different embodiments, different autocorrect techniques could be used by the inventive system. The inventive system will utilize these techniques, matching the user input text to potential valid tokens, by treating the “special input” character as any alphabetic button on the keyboard layout.

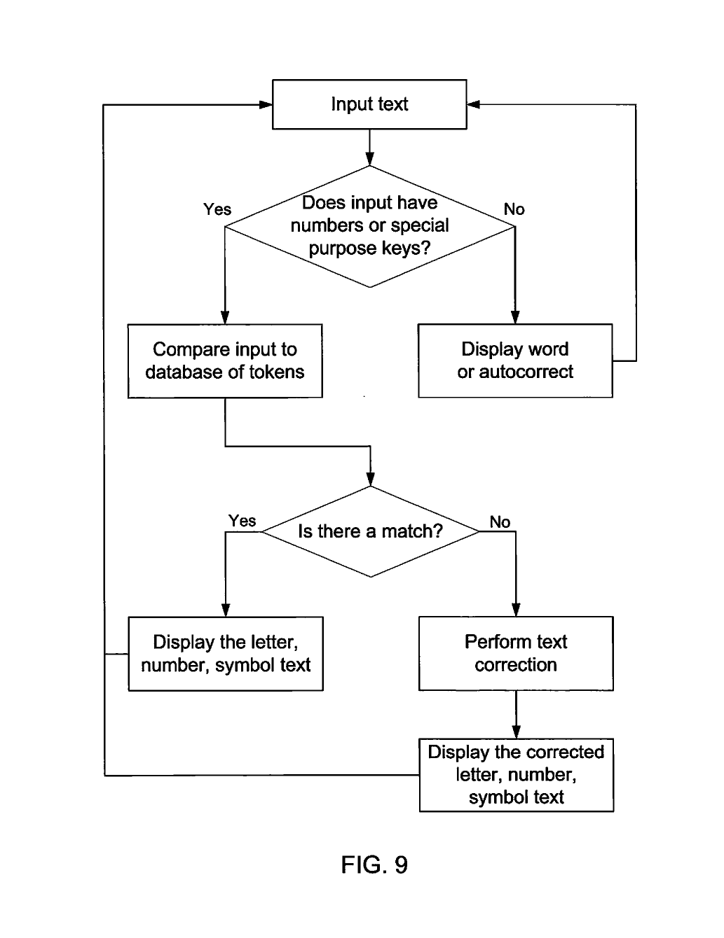

FIG. 9 illustrates a flowchart of the possible processing used to correct mixed letter, number and/or symbol text. The user can input text 301 and the system can then search the text input for numbers or a special purpose key input 303. If the text only includes letters, the system can process the word as normal input or perform normal word auto correction 315. The system can then wait for the next input text 301 from the user and the described process can be repeated. If the input text includes the mixed letter, number and/or symbol the system can compare the input text to a database of tokens 305 and determine if there is a match 307. If there is a match, the system can determine that the mixed text was properly input and the input text can be displayed 309 and then wait for the next input text 301 from the user. If there is no match, the system can perform text correction 311 based upon stored tokens in the token database. The system may then auto correct the input text and display the corrected text 313. The system can then wait for the next input text 301.

It will be understood that the inventive system has been described with reference to particular embodiments, however additions, deletions and changes could be made to these embodiments without departing from the scope of the inventive system. Although the order filling apparatus and method have been described include various components, it is well understood that these components and the described configuration can be modified and rearranged in various other configurations.

What is claimed is:

1. A method for correcting text input through an input device comprising:
providing a token database for storing a plurality of tokens, each of the tokens includes a plurality of letters and a special symbol;
receiving a first text input by an input device that includes a special symbol input;
determining by a processor, that the first text sequence includes the special symbol;
comparing by the processor, the first text sequence to the plurality of tokens in the database of tokens;
determining by the processor, that the first text sequence is similar but not identical to one of the plurality of tokens; and
correcting by the processor, the first text sequence with corrected text associated with the one of the plurality of tokens.

2. The method of claim 1 further comprising:
displaying on a visual display, the corrected text associated with the one of the plurality of tokens.

3. The method of claim 2 wherein the corrected text associated with the one of the plurality of tokens does not include the special symbol.

4. The method of claim 1 wherein the plurality of tokens includes URLs.

5. The method of claim 1 wherein the plurality of tokens includes emails addresses.

6. The method of claim 1 wherein the plurality of tokens includes passwords.

7. The method of claim 1 further comprising:
receiving by an input device, a second text sequence;
determining by a processor, that the second text sequence includes the special symbol;
comparing by the processor, the second text sequence to the plurality of tokens in the database of tokens;
determining by the processor, that the second text sequence is not similar to any of the plurality of tokens; and
displaying on the visual display, the second text sequence.

8. The method of claim 1 further comprising:
receiving a plurality of user defined tokens from the input device; and
storing the plurality of user defined tokens in the token database.

9. The method of claim 1 further comprising:
storing a plurality of previously known tokens to the token database.

10. The method of claim 1 wherein the input device is a virtual keyboard that includes letter keys and a special symbol key.

11. A method for correcting text input through an input device comprising:
providing a token database for storing a plurality of token rules, each of the token rules includes a plurality of letters and a special symbol;
receiving a first text input by an input device that includes a special symbol input;
determining by a processor, that the first text sequence includes the special symbol;
comparing by the processor, the first text sequence to the plurality of token rules in the database of tokens;
determining by the processor, that the first text sequence matches one of the plurality of token rules; and
correcting by the processor, the first text sequence with corrected text associated with the one of the plurality of token rules.

12. The method of claim 11 further comprising:
displaying on a visual display, the corrected text associated with the one of the plurality of token rules.

13. The method of claim 12 wherein the corrected text associated with the one of the plurality of token rules does not include the special symbol.

14. The method of claim 11 wherein the plurality of tokens includes URLs.

15. The method of claim 11 wherein the plurality of tokens includes emails addresses.

16. The method of claim 11 wherein the plurality of tokens includes passwords.

17. The method of claim 11 further comprising:
receiving by an input device, a second text sequence;
determining by a processor, that the second text sequence includes the special symbol;
comparing by the processor, the second text sequence to the plurality of token rules in the database of tokens;
determining by the processor, that the second text sequence is not similar to any of the plurality of token rules; and
displaying on the visual display, the second text sequence.

18. The method of claim 11 further comprising:
receiving a user defined token rule from the input device; and
storing the user defined token rule in the token database.

19. The method of claim 11 further comprising:
storing a plurality of previously known token rules to the token database.

20. The method of claim 11 wherein the input device is a virtual keyboard that includes letter keys and a special symbol key.
